(19) United States
(12) Patent Application Publication
(10) Pub. No.: US 2004/0256542 A1
(43) Pub. Date: Dec. 23, 2004

(54) Optical tweezer device

(75) Inventor: Yoji Okazaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/869,077

(22) Filed: Jun. 17, 2004

(30) Foreign Application Priority Data
Jun. 19, 2003 (JP) 2003-175160

(51) Int. Cl. G01J 1/04; G02B 27/02; G01J 5/08; G01J 1/42

(52) U.S. Cl. 250/227.11

(57) ABSTRACT

An optical tweezer device for capturing minute bodies on a stage in accordance with very fine patterns. A fiber array light source of the device is equipped with a laser module which is structured with a high-luminance, high-power multiplex laser light source. High-intensity laser light which is emitted from this fiber array light source is modulated by a DMD and focused by a microlens array. The focused light enters corresponding optical fiber cores which are arranged in a matrix form at an array head, and is guided in the fibers. The light focused by the microlens array is caused to enter the fiber cores corresponding to the microlenses with high efficiency. The optical fibers are two-dimensionally arrayed to correspond with pixel portions of the DMD. High-intensity laser light is emitted from the array head in accordance with an on-off pattern of the DMD.

This application claims priority under 35 USC 119 from Japanese Patent Application No. 2003-175160, the disclosure of which is incorporated by reference herein.

### BACKGROUND OF THE INVENTION

1. Technical Field

The present invention relates to an optical tweezer device, and more specifically relates to an optical tweezer device which captures tiny particles by irradiating light at the tiny particles.

2. Description of the Related Art

Bottom-up technology, in which atoms and molecules are stacked up to form a desired object, is vital in the field of nanotechnology. The cutting edge of bottom-up technology is the handling of atoms and molecules with scanning tunnelling microscopes (STM), atomic force microscopes (AFM) and the like. However, there is a problem in that this is inappropriate for mass production, because the atoms and molecules are handled with a single probe.

Now, optical tweezer (optical trapping) technology is known in which a tiny particle is captured and arbitrarily moved by utilizing radiation pressure of light which is generated at that tiny particle by focusing laser light from a light source and irradiating the laser light to the vicinity of the tiny particle. A minute body manipulation device, which is equipped with a light source formed by a plurality of surface-emission optical lasers which emit laser light (a VCSEL array) and with a microlens array which focuses the laser lights from this light source at a sample on a stage, has been proposed to serve as an array of such laser tweezers (Japanese Patent Application Laid-Open (JP-A) No. 2002-219700). At this device, minute bodies with diameters of the order of 3 μm are captured and moved by strongly modulating the respective VCSELs spatially and temporally. When optical tweezers are arrayed, it is possible to move a number of minute bodies at the same time.

However, arraying large numbers of active elements such as VCSELs is difficult, and it has not been possible to increase a number of channels to levels such as a million channels or ten million channels. Moreover, it is difficult to obtain high-intensity laser light with VCSEL light sources, and there has been a problem in that it has not been possible to improve trapping forces.

### SUMMARY OF THE INVENTION

The present invention has been devised in order to solve the above-described problems, and an object of the present invention is to provide an optical tweezer device which is capable of multi-channeling when a light pattern that is spatially modulated in accordance with control signals is to be irradiated and which can consistently capture pluralities of minute bodies in accordance with highly detailed patterns.

A first optical tweezer device of the present invention for achieving the object described above includes: a light source for illumination including a first plurality of optical fibers, emission ends of which are bundled, and semiconductor lasers, laser lights of which are coupled at respective incidence ends of the plurality of optical fibers; a spatial light modulation device including a plurality of pixel portions which are two-dimensionally arranged, light modulation states of the pixel portions changing in accordance with respective control signals, and light beams which are incident at the plurality of pixel portions from the light source being modulated at the respective pixel portions; and an optical fiber array including a second plurality of optical fibers, incidence ends of which are two-dimensionally arranged with a pitch corresponding to the light beams that have been modulated by the pixel portions, and emission ends of which include spherical surfaces. A light beam from each emission end of the second plurality of optical fibers can be irradiated at a minute body for capturing a minute body at each optical fiber.

In the first optical tweezer device of the present invention, the light beams that are incident on the spatial light modulation device from the illumination light source are modulated at each pixel portion of the spatial light modulation device in accordance with control signals. The illumination light source, which is provided with the first plurality of optical fibers whose emission ends are bundled and the semiconductor lasers whose laser lights are coupled at the respective incidence ends of the first plurality of optical fibers, has a small emission end area, high output and high luminance. At the optical fiber array, the incidence ends of the second plurality of optical fibers are two-dimensionally arrayed with the pitch corresponding to the light beams that are modulated by the plurality of pixel portions. Accordingly, light beams which have been irradiated from the illumination light source and modulated at the respective pixel portions of the spatial light modulation device enter with high efficiency at the respective incidence ends of the plurality of optical fibers which are arrayed in the optical fiber array.

When the high-intensity light beams which are emitted from the respective spherical-faced emission ends of this second plurality of optical fibers is irradiated at minute bodies, the minute bodies can be consistently captured at each optical fiber. That is, when a pattern of light which is spatially modulated in accordance with control signals is to be irradiated, because of the spatial light modulation device at which the plurality of pixel portions whose light modulation states change in accordance with the respective control signals are two-dimensionally arranged, it is possible to dramatically increase a number of channels to a level such as a million channels, ten million channels or the like. Thus, it is possible to reliably capture pluralities of minute bodies in accordance with very fine patterns.

In the first optical tweezer device described above, the light source may utilize a multiplex laser light source which multiplexes a plurality of the laser lights emitted from each of the plurality of semiconductor lasers and emits a light beam for illumination. When high-power, high-luminance multiplex laser light sources are employed, high-intensity light beams can be irradiated at minute bodies, and the minute bodies can be reliably captured. The multiplex laser light source is provided with a plurality of semiconductor lasers, a single optical fiber, and a focusing optical system. The focusing optical system focuses laser light that is emitted from each of the plurality of semiconductor lasers and couples the focused beam at the incidence end of the optical fiber. Thus, the multiplex laser light source multiplexes the plurality of laser lights and makes the same respectively incident at the optical fiber, and can structure a fiber light source which emits light beams for illumination.

In the first optical tweezer device described above, the light source may utilize a fiber light source which includes an optical fiber and a semiconductor laser whose laser light is coupled at an incidence end of the optical fiber, a core diameter of the optical fiber being constant, an emission end cladding diameter of the optical fiber being smaller than an incidence end cladding diameter thereof, and the emission end of the optical fiber being plurally bundled. Because the cladding diameter of the emission ends of these optical fibers is smaller than the cladding diameter of the incidence ends, an increase in luminance can be provided for with ease.

A second optical tweezer device of the present invention for achieving the object described above includes: a light source for illumination including a first plurality of optical fibers, emission ends of which are bundled, and semiconductor lasers, laser lights of which are coupled at respective incidence ends of the plurality of optical fibers; a spatial light modulation device including a plurality of pixel portions which are two-dimensionally arranged, light modulation states of the pixel portions changing in accordance with respective control signals, and light beams which are incident at the plurality of pixel portions from the light source being modulated at the respective pixel portions; a microlens array including a plurality of microlenses which are two-dimensionally arranged with a pitch corresponding to the plurality of pixel portions, the microlens array focusing the light beams that have been modulated by the pixel portions at the respective microlenses; and an optical fiber array including a second plurality of optical fibers, incidence ends of which are two-dimensionally arranged with a pitch corresponding to focusing positions of the plurality of microlenses, and emission ends of which include spherical surfaces. A light beam from each emission end of the second plurality of optical fibers can be irradiated at a minute body for capturing a minute body at each optical fiber.

In the second optical tweezer device of the present invention, the light beams that are incident on the spatial light modulation device from the illumination light source are modulated at each pixel portion of the spatial light modulation device in accordance with control signals. The light beams that have been modulated by the pixel portions are focused at the respective microlenses of the microlens array. The illumination light source, which is provided with the first plurality of optical fibers whose emission ends are bundled and the semiconductor lasers whose laser lights are coupled at the respective incidence ends of the plurality of optical fibers, has a small emission end area, high output and high luminance. At the optical fiber array, the incidence ends of the second plurality of optical fibers are two-dimensionally arrayed with the pitch corresponding to the focusing positions of the plurality of microlenses. Accordingly, the light beams which have been irradiated from the illumination light source, modulated at the respective pixel portions of the spatial light modulation device, and focused by the microlens array enter with high efficiency at the respective incidence ends of the plurality of optical fibers which are arrayed in the optical fiber array.

When the high-intensity light beams which are emitted from the respective spherical-faced emission ends of this second plurality of optical fibers are irradiated at minute bodies, the minute bodies can be consistently captured at each optical fiber. That is, when a pattern of light which is spatially modulated in accordance with control signals is to be irradiated, because of the spatial light modulation device at which the plurality of pixel portions whose light modulation states change in accordance with the respective control signals are two-dimensionally arranged, it is possible to dramatically increase a number of channels to a level such as a million channels, ten million channels or the like. Thus, it is possible to reliably capture pluralities of minute bodies in accordance with highly detailed patterns.

In the second optical tweezer device described above, the incidence ends of the second plurality of optical fibers may be fixedly disposed with the emission ends of the second plurality of optical fibers being movable. For example, when a length of the optical fibers is long, the incidence ends of the optical fibers can be fixedly disposed and the emission ends thereof made movable.

In the second optical tweezer device described above, when the above-described high-power, high-luminance multiplex laser light source is employed for the light source, a high-intensity light beam can be irradiated at a minute body, and the minute body can be reliably captured. When the light source utilizes the fiber light source which includes the optical fiber and the semiconductor laser whose laser light is coupled at the incidence end of the optical fiber, with the core diameter of the optical fiber being constant, the emission end cladding diameter of the optical fiber being smaller than the incidence end cladding diameter thereof, and the emission end of the optical fiber being plurally bundled, an increase in luminance can be provided for with ease.

A third optical tweezer device of the present invention for achieving the object described above includes: a light source for illumination including a plurality of optical fibers, emission ends of which are bundled, and semiconductor lasers, laser lights of which are coupled at respective incidence ends of the plurality of optical fibers; a spatial light modulation device including a plurality of pixel portions which are two-dimensionally arranged, light modulation states of the pixel portions changing in accordance with respective control signals, and light beams which are incident at the plurality of pixel portions from the light source being modulated at the respective pixel portions; and a microlens array including a plurality of microlenses which are two-dimensionally arranged with a pitch corresponding to the plurality of pixel portions, the microlens array focusing the light beams that have been modulated by the pixel portions at the respective microlenses. At each microlens, the respective light beam that has been focused can be irradiated at a minute body for capturing a minute body at the each microlens.

In the third optical tweezer device of the present invention, the light beams that are incident on the spatial light modulation device from the illumination light source are modulated at each pixel portion of the spatial light modulation device in accordance with control signals. The light beams that have been modulated by the pixel portions are focused at the respective microlenses of the microlens array. The illumination light source, which is provided with the plurality of optical fibers whose emission ends are bundled and the semiconductor lasers whose laser lights are coupled at the respective incidence ends of the plurality of optical fibers, has a small emission end area, high output and high luminance. When the respective high-intensity light beams that are irradiated from the illumination light source, modulated at the respective pixel portions of the spatial light modulation device, and focused at the respective microlenses are irradiated, a minute body can be reliably captured at each microlens. That is, when a pattern of light which is spatially modulated in accordance with control signals is to be irradiated, because of the spatial light modulation device at which the plurality of pixel portions whose light modulation states change in accordance with the respective control signals are two-dimensionally arranged, it is possible to dramatically increase a number of channels to a level such as a million channels, ten million channels or the like. Thus, it is possible to reliably capture pluralities of minute bodies in accordance with highly detailed patterns.

In the third optical tweezer device described above, it is possible to structure the microlenses with fresnel lenses. A fresnel lens array can be produced by semiconductor processes. Thus, a high-density, high-accuracy, high-NA (numerical aperture) microlens array can be realized at low cost.

In the third optical tweezer device described above, when the above-described high-power, high-luminance multiplex laser light source is employed for the light source, a high-intensity light beam can be irradiated at a minute body, and the minute body can be reliably captured. When the light source utilizes the fiber light source which includes the optical fiber and the semiconductor laser whose laser light is coupled at the incidence end of the optical fiber, with the core diameter of the optical fiber being constant, the emission end cladding diameter of the optical fiber being smaller than the incidence end cladding diameter thereof, and the emission end of the optical fiber being plurally bundled, an increase in luminance is provided for with ease.

A fourth optical tweezer device of the present invention for achieving the object described above includes: a light source for illumination including a plurality of optical fibers, emission ends of which are bundled, and semiconductor lasers, laser lights of which are coupled at respective incidence ends of the plurality of optical fibers; a spatial light modulation device including a plurality of pixel portions which are two-dimensionally arranged, light modulation states of the pixel portions changing in accordance with respective control signals, and light beams which are incident at the plurality of pixel portions from the light source being modulated at the respective pixel portions; a microlens array including a plurality of microlenses which are two-dimensionally arranged with a pitch corresponding to the plurality of pixel portions, the microlens array focusing the light beams that have been modulated by the pixel portions at the respective microlenses; and a light-blocking layer provided at a light emission face of the microlens array and including a plurality of tiny apertures which are two-dimensionally arranged with a pitch corresponding to focusing positions of the plurality of microlenses. Near-field light which effuses from each tiny aperture can be irradiated at a minute body for capturing a minute body at the each tiny aperture.

In the fourth optical tweezer device of the present invention, the light beams that are incident on the spatial light modulation device from the illumination light source are modulated at each pixel portion of the spatial light modulation device in accordance with control signals. The light beams that have been modulated by the pixel portions are focused at the respective microlenses of the microlens array. The illumination light source, which is provided with the plurality of optical fibers whose emission ends are bundled and the semiconductor lasers whose laser lights are coupled at the respective incidence ends of the plurality of optical fibers, has a small emission end area, high output and high luminance. At the microlens array, the plurality of microlenses are arrayed two-dimensionally with the pitch corresponding to the plurality of pixel portions. Accordingly, the light beams which have been irradiated from the illumination light source and modulated at the respective pixel portions of the spatial light modulation device enter the respective microlenses with high efficiency.

The light-blocking layer, in which the plurality of tiny apertures are two-dimensionally arrayed with the pitch corresponding to the focusing positions of the plurality of microlenses, is disposed at the light emission face of the microlens array. A minute body can be reliably captured at each tiny aperture by irradiating high-intensity near-field light, which is effuses through each of the plurality of tiny apertures, at the minute body. That is, when a pattern of light which is spatially modulated in accordance with control signals is to be irradiated, because of the spatial light modulation device at which the plurality of pixel portions whose light modulation states change in accordance with the respective control signals are two-dimensionally arranged, it is possible to dramatically increase a number of channels to a level such as a million channels, ten million channels or the like. Thus, it is possible to reliably capture pluralities of minute bodies in accordance with highly detailed patterns.

In the fourth optical tweezer device described above, when the above-described high-power, high-luminance multiplex laser light source is employed for the light source, a high-intensity light beam can be irradiated at a minute body, and the minute body can be reliably captured. When the light source utilizes the fiber light source which includes the optical fiber and the semiconductor laser whose laser light is coupled at the incidence end of the optical fiber, with the core diameter of the optical fiber being constant, the emission end cladding diameter of the optical fiber being smaller than the incidence end cladding diameter thereof, and the emission end of the optical fiber being plurally bundled, an increase in luminance can be provided for with ease.

Further, when near-field light is utilized, as in the fourth optical tweezer device, high-intensity light energy which has a diameter less than or equal to the wavelength of the light and which is localized can be formed. Hence, it becomes possible to capture a minute body smaller than the wavelength of the light (for example, 100 nm or less). In particular, when near-field light with a wavelength in the vicinity of 400 nm is used, an improvement in trapping forces of minute bodies is made possible by a synergistic effect between a high photon energy of this light and energy localization of the near field.

### BRIEF DESCRIPTION OF THE DRAWINGS

FIG. 1 is a sectional view, cut along an optical axis, showing structure of an exposure apparatus relating to a first embodiment.

FIG. 2 is a perspective view showing structure of a near-field array head which is used in the exposure apparatus shown in FIG. 1.

FIG. 3 is a partial enlarged view showing structure of a DMD.

FIGS. 4A and 4B are explanatory views for explaining operation of the DMD.

FIG. 5A is a perspective view showing structure of a fiber array light source.

FIG. 5B is a plan view showing an array of light emission points at a laser emission portion of FIG. 5A.

FIG. 6 is a sectional view, cut along an optical axis, showing structure of an exposure apparatus relating to a second embodiment.

FIG. 7 is a sectional view, cut along an optical axis, showing structure of an exposure apparatus relating to a third embodiment.

FIG. 8A is a perspective view showing structure of a near-field array head which is used in the exposure apparatus shown in FIG. 7.

FIG. 8B is a sectional view, cut along the optical axis, of FIG. 8A.

FIG. 9 is a perspective view showing structure of a microlens array which can be employed instead of the near-field array head.

FIGS. 10A to 10C are views showing a variant example of the near-field array head.

FIG. 11 is a plan view showing structure of a multiplex laser light source.

FIG. 12 is a plan view showing structure of a laser module.

FIG. 13 is a side view showing structure of the laser module shown in FIG. 12.

FIG. 14 is a partial side view showing structure of the laser module shown in FIG. 12.

### DETAILED DESCRIPTION OF THE INVENTION

Below, embodiments of the present invention will be described in detail with reference to the drawings.

### FIRST EMBODIMENT

General Structure of Optical Tweezer Device

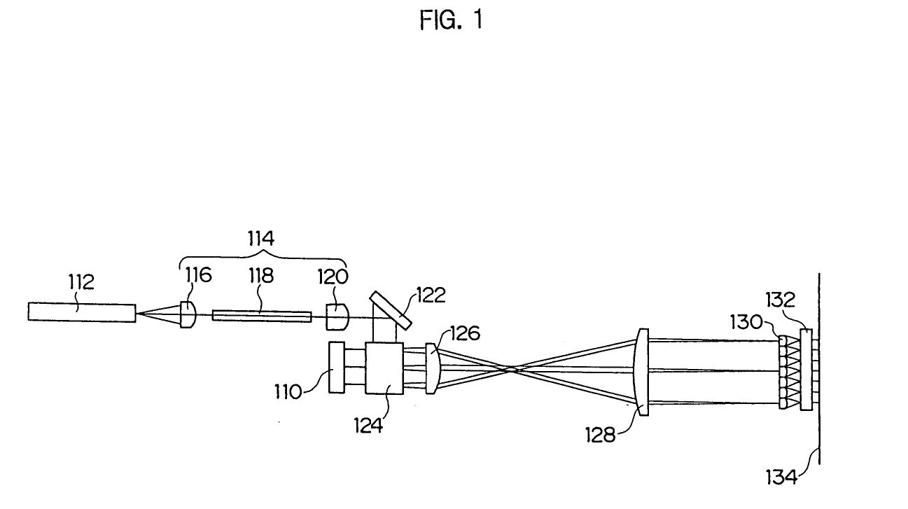

As shown in FIG. 1, an optical tweezer device relating to a first embodiment is provided with a digital micromirror device (DMD) 110, which serves as a spatial light modulation device for modulating incident light beams at respective pixels in accordance with image data. The DMD 110 is connected to an unillustrated controller, which is provided with a data processing section and a mirror driving control section. At the data processing section of this controller, on the basis of inputted image data, driving signals are generated for driving-control of each micromirror of the DMD 110. The mirror driving control section controls the angle of a reflection surface of each micromirror of the DMD 110 on the basis of the control signals generated at the image data processing section. Control of the angles of the reflection faces will be described later.

At a light incidence side of the DMD 110, a fiber array light source 112, a lens system 114 and mirrors 122 and 124 are disposed in this order. The fiber array light source 112 is equipped with a laser emission portion at which emission end portions (light emission points) of optical fibers are arranged in a row along a predetermined direction. The lens system 114 corrects laser light that is emitted from the fiber array light source 112, and focuses the light on the DMD. The mirrors 122 and 124 reflect the laser light that has been transmitted through the lens system 114 toward the DMD 110.

The lens system 114 is structured by a pair of combination lenses 116, a rod integrator 118 and a focusing lens 120. The combination lenses 116 convert the laser light that is emitted from the fiber array light source 112 to parallel light. The rod integrator 118 corrects so as to make a light amount distribution of the laser light that has been made parallel uniform. The focusing lens 120 focuses the laser light whose light amount distribution has been corrected onto the DMD. The rod integrator 118 guides the light while completely reflecting the light within an integrator, and thus can correct the laser light such that the light distribution is more uniform.

Meanwhile, at a light reflection side of the DMD 110, magnifying lens systems 126 and 128 are provided. The magnifying lens systems 126 and 128 magnify a DMD image which has been reflected at the DMD 110. A microlens array 130 is disposed at a position at which the DMD image is focused by the magnifying lens systems 126 and 128. At the microlens array 130, microlenses are provided in correspondence with the respective pixels of the DMD. Furthermore, an array head 132 is disposed at a light emission side of the microlens array 130. The array head 132 is disposed near a surface of a stage 134, so as to capture minute bodies that are present on the stage 134.

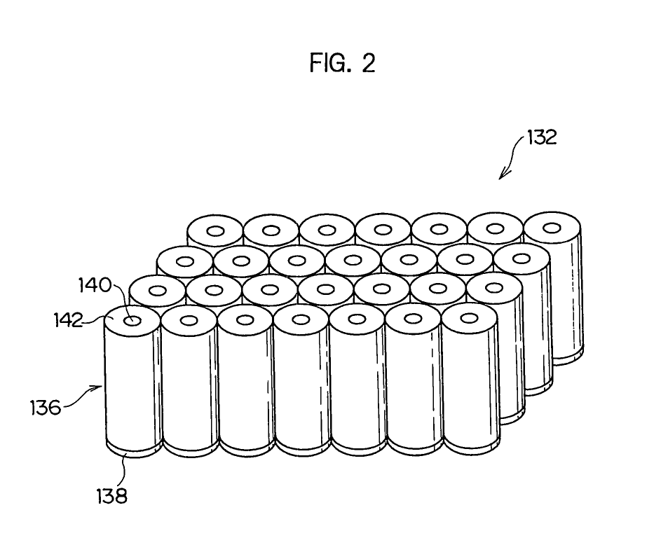

As shown in FIG. 2, the array head 132 is structured by a bundled plurality of optical fibers 136. The optical fibers 136 are provided with cores 140 and claddings 142. At incidence ends of the optical fibers 136, the cores 140 are arranged in a matrix pattern to correspond with focusing positions of the microlens array 130. End portions 138, at emission ends of the optical fibers 136, are formed as spherical surfaces. When laser light is introduced from the other ends of the optical fibers 136, the light is emitted through these end portions 138. The light that is emitted from the spherical-faced end portions 138 converges along the optical axes, which is excellent for trapping minute bodies.

Here, FIG. 2 shows an example in which twenty-eight of the optical fibers 136 are bundled, and the cores 140 thereof are arranged in a matrix pattern of four columns and seven rows. In practice however, the array head 132 is structured by bundling the optical fibers 136 in the same number as the number of microlenses arranged at the microlens array 130.

A beam diameter of a light beam that has been focused by the microlens array 130 is preferably of the same magnitude as a diameter of the core 140 of the optical fiber 136. When these diameters have the same magnitude, a coupling efficiency of the light beam into the optical fiber 136 is higher. For example, in a case of using a single-mode fiber with a core diameter of 4 μm, in order to realize a high coupling efficiency, the diameters of the focused beam and the optical fiber beam are matched and, in order to attain mode matching, the beam diameter of the focused light beam is set to 4 μm.

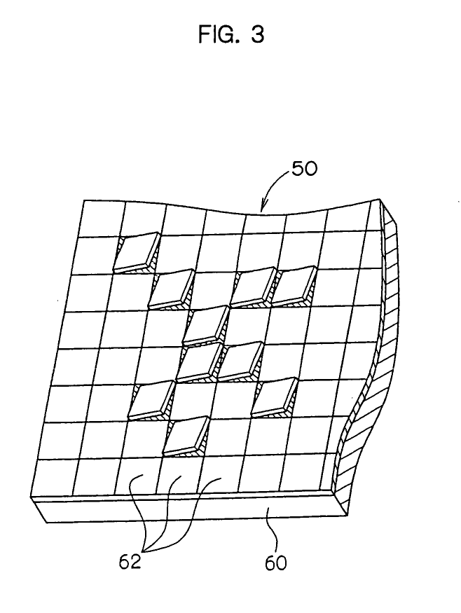

As shown in FIG. 3, at the DMD 110, very small mirrors (micromirrors) 62, which are supported by support pillars, are disposed on an SRAM cell (memory cell) 60. The DMD 110 is a mirror device which is structured with a large number (for example, 600 by 800) of these extremely small mirrors, which structure image elements (pixels), arranged in a checkerboard pattern. At each pixel, the micromirror 62 is provided so as to be supported at an uppermost portion of the support pillar. A material with high reflectivity, such as aluminium or the like, is applied by vapor deposition at the surface of the micromirror 62. Reflectivity of the micromirror 62 is at least 90%. The SRAM cell 60, which is fabricated with CMOS silicon gates by a continuous semiconductor memory production line, is disposed directly under the micromirror 62, with the support pillar, which includes a hinge and a yoke, interposed therebetween. The whole of this structure is monolithic (integrated).

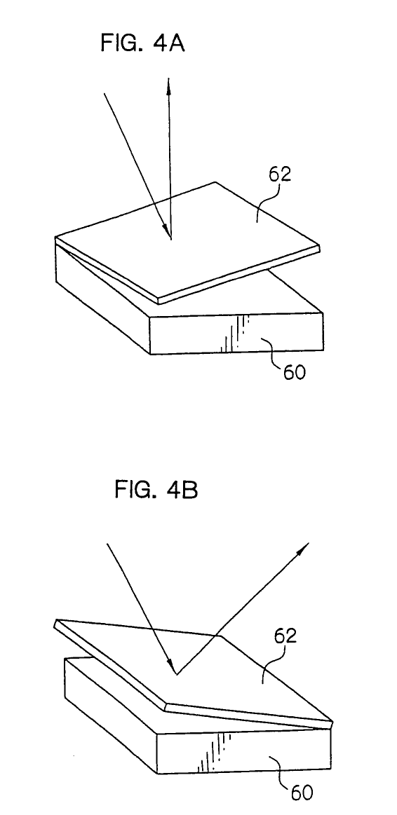

When digital signals are written to the SRAM cell 60 of the DMD 110, the micromirrors 62 supported at the support pillars are inclined, about a diagonal, in a range of ±α° (for example, ±10°), relative to the side of the support at which the DMD 110 is disposed. FIG. 4A shows a state in which the micromirror 62 is inclined at +α°, which is an ‘ON’ state, and FIG. 4B shows a state in which the micromirror 62 is inclined at −α°, which is an ‘OFF’ state. Accordingly, as a result of control of the inclinations of the micromirrors 62 at the pixels of the DMD 110 in accordance with image signals, as shown in FIG. 3, light that is incident at the DMD 110 is reflected in directions of inclination of the respective micromirrors 62.

FIG. 3 shows a portion of the DMD 110 enlarged, and shows an example of a state in which the micromirrors 62 are controlled to +α° and −α°. The ON-OFF control of the respective micromirrors 62 is carried out by the unillustrated controller connected to the DMD 110. A light-absorbing body (not shown) is disposed in a direction in which light beams are reflected by the micromirrors 62 in the OFF state.

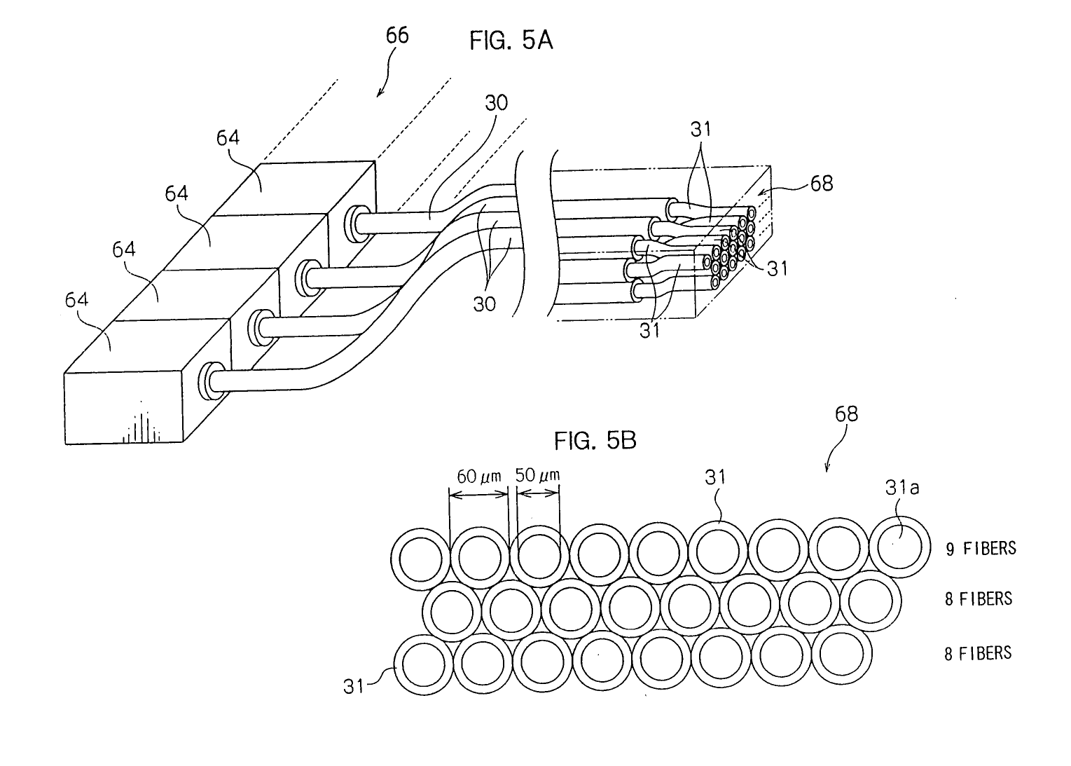

As shown in FIG. 5A, the fiber array light source 112 is equipped with a plurality (twenty-five in the drawings) of laser modules 64. At each of the laser modules 64, one end of a multi-mode optical fiber 30 is connected. At the other end of the multi-mode optical fiber 30, an optical fiber 31, whose core diameter is the same as that of the multi-mode optical fiber 30 and whose cladding diameter is smaller than that of the multi-mode optical fiber 30, is connected. As shown in FIG. 5B, emission end portions of the optical fibers 31 (light emission points) are arranged in a number of rows (three in the drawings) along the predetermined direction, to structure a laser emission portion 68.

As the multi-mode optical fibers 30 and the optical fibers 31, any of step index-type optical fibers, graded index-type optical fibers and multiplex-type optical fibers can be used. For example, a step index-type optical fiber produced by Mitsubishi Cable Industries, Ltd. can be used. In the present embodiment, the multi-mode optical fibers 30 and the optical fibers 31 are step index-type optical fibers. The multi-mode optical fibers 30 have cladding diameter=125 μm, core diameter=50 μm, NA=0.2, and transmittance of an end face coating=99.5% or more. The optical fibers 31 have cladding diameter=60 μm, core diameter=50 μm, and NA=0.2.

The cladding diameter of the optical fibers 31 is not limited to 60 μm. An optical fiber which is employed in a conventional fiber light source has a cladding diameter of 125 μm. However, because a light source can be increased in intensity as the cladding diameter become smaller, it is preferable if the cladding diameter of the multi-mode optical fibers is 80 μm or less, more preferably 60 μm or less, and even more preferably 40 μm or less. On the other hand, given that the core diameter needs to be at least 3 to 4 μm, it is preferable if the cladding diameter of the optical fibers 31 is not less than 10 μm.

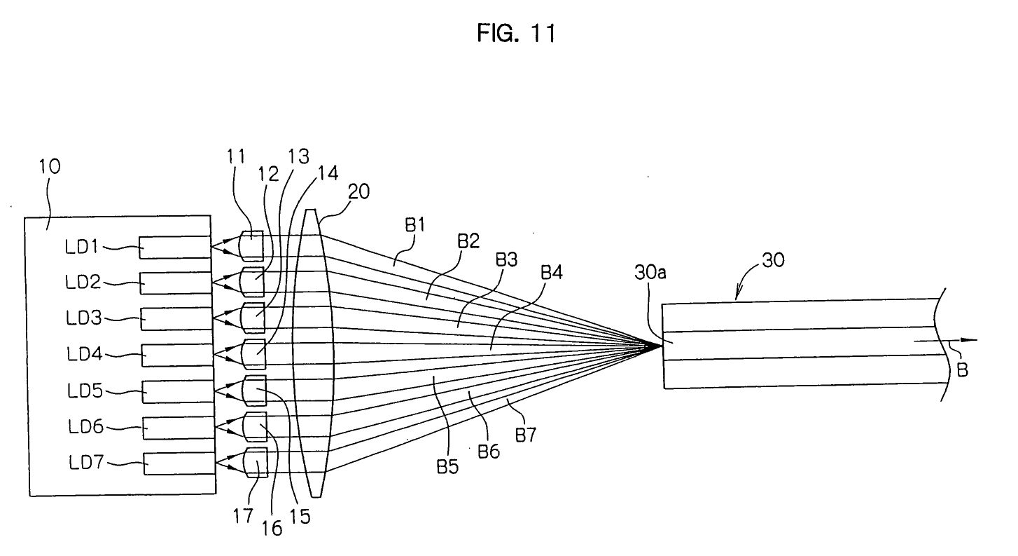

The laser module 64 is structured by a multiplexed laser light source (fiber light source) shown in FIG. 11. This multiplex laser light source is structured with a plurality (for example, seven) of chip-form lateral multi-mode or single-mode GaN-based semiconductor lasers LD1, LD2, LD3, LD4, LD5, LD6 and LD7, collimator lenses 11, 12, 13, 14, 15, 16 and 17, a single condensing lens 20, and one of the multi-mode optical fibers 30. The GaN-based semiconductor lasers LD1 to LD7 are fixedly arranged on a heat block 10. The collimator lenses 11 to 17 are provided in correspondence with the GaN-based semiconductor lasers LD1 to LD7, respectively. Note that the number of semiconductor lasers is not limited to seven. For example, with a multi-mode optical fiber with cladding diameter=60 μm, core diameter=50 μm and NA=0.2, it is possible for the light of as many as twenty semiconductor lasers to be incident therein, and it is possible to realize an illumination head with a required light amount while further reducing the number of optical fibers.

The GaN-based semiconductor lasers LD1 to LD7 all have a common oscillation wavelength (for example, 405 nm), and a common maximum output (for example, 100 mW with multi-mode lasers, 30 mW with single-mode lasers). As the GaN-based semiconductor lasers LD1 to LD7, lasers may be utilized which are provided with an oscillation wavelength different from the above-mentioned 405 nm, in a wavelength range of 350 nm to 450 nm. Suitable Wavelength ranges will be discussed later.

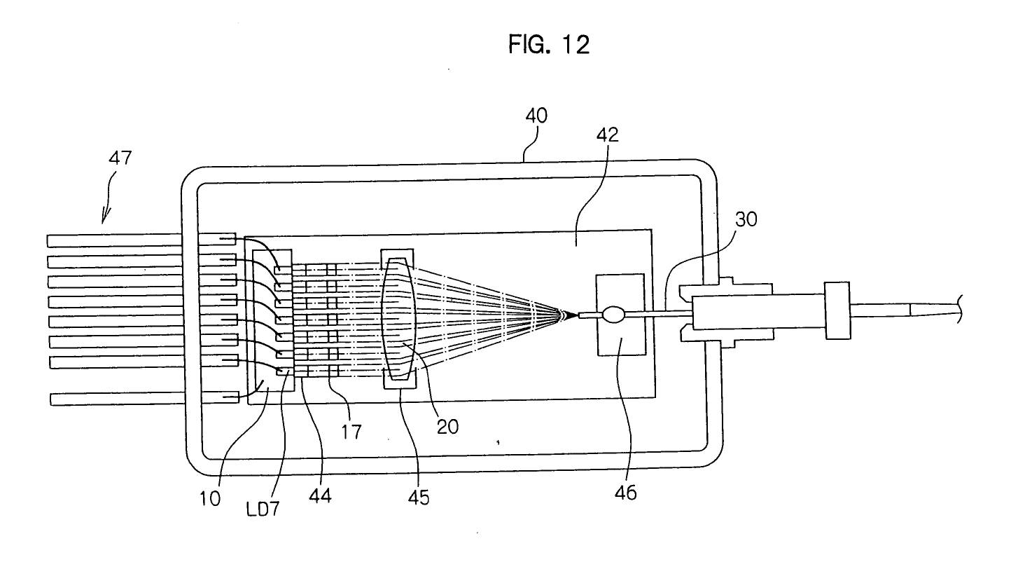

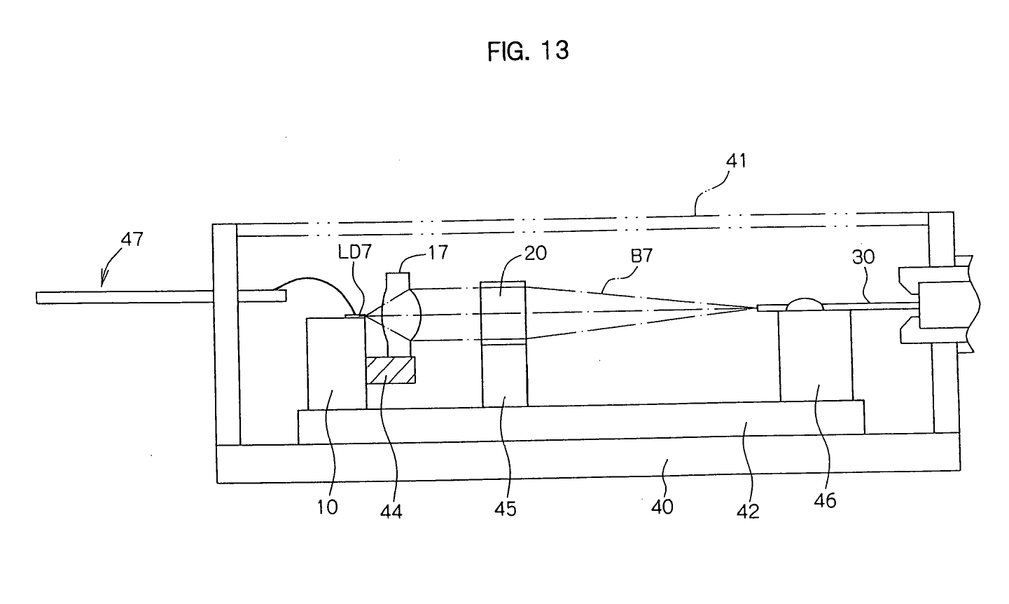

As shown in FIGS. 12 and 13, the above-described multiplex laser light source, together with other optical elements, is accommodated in a box-like package 40 which opens upward. The package 40 is provided with a package lid 41 prepared so as to close the opening of the package 40. After an air removal treatment, sealed gas is introduced and the opening of the package 40 is closed by the package lid 41. Thus, the above-described multiplex laser light source is hermetically sealed in a closed space (sealed space) formed by the package 40 and the package lid 41.

A baseplate 42 is fixed at a lower face of the package 40. The heat block 10, a condensing lens holder 45 and a fiber holder 46 are attached at an upper face of the baseplate 42. The condensing lens holder 45 retains the condensing lens 20. The fiber holder 46 retains an incidence end portion of the multi-mode optical fiber 30. An opening is formed in a wall face of the package 40. An emission end portion of the multi-mode optical fiber 30 is led out through this opening to outside the package.

A collimator lens holder 44 is attached at a side face of the heat block 10, and retains the collimator lenses 11 to 17. Openings are formed in a lateral wall face of the package 40. Wiring 47, which supplies driving current to the GaN-based semiconductor lasers LD1 to LD7, is passed through these openings and led out to outside the package.

Note that in FIG. 12, in order to alleviate complexity of the drawing, of the plurality of GaN-based semiconductor lasers, only the GaN-based semiconductor laser LD7 is marked with a reference numeral, and of the plurality of collimator lenses, only the collimator lens 17 is marked with a reference numeral.

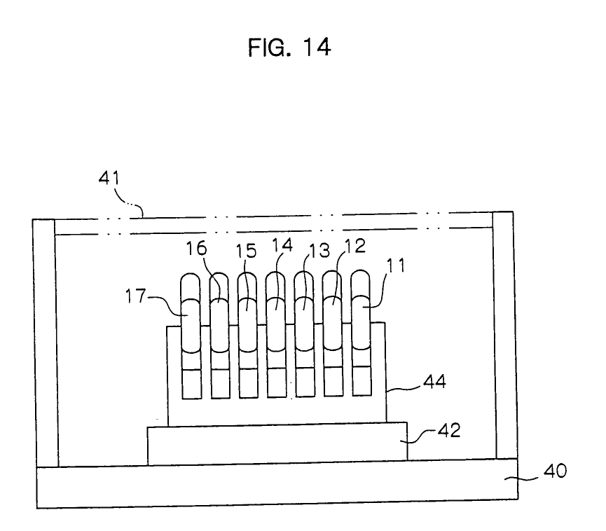

FIG. 14 shows the collimator lenses 11 to 17 and mounting portions thereof, as viewed from front faces thereof. Each of the collimator lenses 11 to 17 has a long, narrow, cut-down shape with parallel flat faces defining a region that includes an optical axis of a circular-form lens which is provided with an aspherical surface. The collimator lenses with this long, narrow shape may be formed, for example, by molding-formation of resin or optical glass. The collimator lenses 11 to 17 are closely disposed in a direction of arrangement of light emission points of the GaN-based semiconductor lasers LD1 to LD7 (the left-right direction in FIG. 14) such that the length directions of the collimator lenses 11 to 17 cross the direction of arrangement of the light emission points.

As the GaN-based semiconductor lasers LD1 to LD7, lasers are employed which are provided with an active layer with a light emission width of 2 μm, and which respectively emit laser beams B1 to B7 in forms which widen at angles of, for example, 10° and 30° with respect, respectively, to a direction parallel to the active layers and a direction perpendicular to the active layers. These GaN-based semiconductor lasers LD1 to LD7 are disposed such that the light emission points thereof are lined up in a single row in the direction parallel to the active layers.

Accordingly, the laser beams B1 to B7 emitted from the respective light emission points are irradiated to, respectively, the collimator lenses 11 to 17 having the long, narrow forms described above, in states in which the direction for which the spreading angle of the beam is greater coincides with the length direction of the lens and the direction in which the spreading angle is smaller coincides with a width direction of the lens (a direction intersecting the length direction). Specifically, the width of each of the collimator lenses 11 to 17 is 1.1 mm and the length thereof is 4.6 mm, and the laser beams B1 to B7 incident thereat have beam diameters in the horizontal direction and the vertical direction of 0.9 mm and 2.6 mm, respectively. Further, each of the collimator lenses 11 to 17 has a focusing length f₁=3 mm, NA=0.6 and lens arrangement pitch=1.25 mm.

The condensing lens 20 is cut away in a long, narrow shape with parallel flat faces defining a region that includes an optical axis of a circular-form lens which is provided with an aspherical surface, and is formed in a shape which is long in the direction of arrangement of the collimator lenses 11 to 17 (i.e., the horizontal direction) and short in a direction perpendicular thereto. The condensing lens 20 has focusing distance f₂=23 mm and NA=0.2. The condensing lens 20 is also formed by, for example, molding-formation of resin or optical glass.

At a fiber array light source 66 that is structured thus, the respective laser beams B1, B2, B3, B4, B5, B6 and B7, which are emitted in divergent forms from the respective GaN-based semiconductor lasers LD1 to LD7 that structure the multiplex laser light source, are converted to parallel light by the corresponding collimator lenses 11 to 17. The laser beams B1 to B7 that have been thus collimated are focused by the condensing lens 20, and converge at the incidence end face of a core 30a of the multi-mode optical fiber 30.

A condensing optical system is structured by the collimator lenses 11 to 17 and the condensing lens 20, and a multiplexing optical system is structured by this condensing optical system and the multi-mode optical fiber 30. Thus, the laser beams B1 to B7 focused by the condensing lens 20 as described above enter the core 30a of the multi-node optical fiber 30 and are propagated in the optical fiber, multiplexed to a single laser beam B, coupled at an emission end portion of the multi-mode optical fiber 30, and emitted from the optical fiber 31.

In each laser module, a coupling efficiency of the laser beams B1 to B7 into the multi-mode optical fiber 30 is 0.85. Therefore, if the respective outputs of the GaN-based semiconductor lasers LD1 to LD7 are 30 mW (in a case in which single-mode lasers are used), the multiplexed laser beam B can be provided with an output of 180 mW (=30 mW×0.85×7) from each of the optical fibers 31 arranged in an array pattern. Accordingly, output of the laser emission portion 68 in which twenty-five of the optical fibers 31 are arranged in the array pattern is approximately 4.5 W (=180 mW×25).

In the laser emission portion 68 of the fiber array light source 66, the light emission points having high luminance as described above are arranged along a main scanning direction. Because conventional fiber light sources, in which laser lights from single semiconductor lasers are coupled to single optical fibers, have low output, it has not been possible to provide desired outputs without arranging pluralities of rows thereof. In contrast, because the laser light source that is employed in the present embodiment has high output, this laser light source can be used for an illumination light source that has sufficiently high output even with a small number of laser light sources. Furthermore, in the optical tweezer device of the present embodiment, because a diameter in a direction intersecting the predetermined direction of the light emission area of the fiber array light source 112 is small, an angle of flux that passes through the lens system 114 and is incident on the DMD 110 is small. As a result, an angle of flux that enters the array head 132 is small. In other words, luminance is high.

In, for example, a conventional fiber light source in which semiconductor lasers are coupled to optical fibers in a one-to-one relationship, lasers with outputs of around 30 mW (milliwatts) are commonly employed as the semiconductor lasers, and optical fibers with core diameter 50 μm, cladding diameter 125 μm, and NA (aperture number) 0.2 are employed as multi-mode optical fibers. Thus, if an output of around 4.5 W (watts) is to be obtained, two hundred and twenty-five (fifteen by fifteen) multi-mode optical fibers must be bundled. Thus, with a light emission region with an area of 3.6 mm² (1.9 mm by 1.9 mm), luminance of a laser emission portion thereof is 1.25 W/mm², and the luminance of each optical fiber is 10 W/mm².

In contrast, in the present embodiment, an output of approximately 4.5 W can be provided by twenty-five multi-node optical fibers, as described above. Thus, from a light emission region of the laser emission portion 68 with an area of 0.2 mm² (0.18 mm×1.13 mm), luminance of the laser emission portion 68 is 22.5 W/mm². Therefore, a luminance about eighteen times higher than in the conventional case can be expected. Furthermore, the luminance per optical fiber is 90 W/mm². Thus, a luminance around nine times higher than in the conventional case can be expected.

A blue laser with an oscillation wavelength in the vicinity of 400 nm serves excellently as a semiconductor laser structuring the multiplex laser light source. With blue lasers, restriction of the converging beams of the microlens array 130 is more feasible. As a result, light coupling with high efficiency at the array head is possible, and light of high-intensity can be supplied to the array head. Further, given a short wavelength light source whose excitation wavelength is in the vicinity of 400 nm, an object trapping force of the array head can be raised due to the high intensity of the light and the high photon energy of the light.

Now, although an example has been described above in which light from single mode lasers is multiplexed, it is also possible to provide light source output with higher intensity by multiplexing and coupling light from multi-mode high-power (for example, 200 mW) lasers. For example, in a case in which the respective outputs of multi-mode lasers are 200 mW, the multiplexed laser beam B can be obtained with an output of 1 W (=200 mW×0.85×6) from each of the optical fibers 31 arranged in an array pattern. Accordingly, output of the laser emission portion 68, in which five of the optical fibers 31 are arranged in the array pattern, is approximately 5 W (=1 W×5).

Further, although a case has been described hitherto in which a-plurality of semiconductor lasers are multiplexed, it is also possible, rather than multiplexing, to couple semiconductor lasers with optical fibers in one-to-one relationships and, at distal ends of these fibers, similarly to the case of multiplexing, to couple optical fibers whose cladding diameters are smaller (for example, with the same core diameter, a cladding diameter of 60 μm). Specifically, in such a case, it is preferable to use multi-mode high output lasers (200 mW) as the semiconductor lasers. When such high output lasers are used, high-intensity light sources can be provided. Intensity in such a case can be realized with an intensity of 4 times that in a structure in which semiconductor lasers are simply coupled with usual optical fibers in one-to-one relationships, because a light emission area can be quartered (×¼).

Furthermore, in a light source with the structure described above which couples semiconductor lasers with optical fibers in one-to-one relationships, optical fibers with cladding thickness 5 μm, core diameter 50 μm and cladding diameter 60 μm can be used with lasers with wavelength 400 nm. When a small-diameter optical fiber is used thus, a light emission area can be quartered relative to structures which use optical fibers with core diameter 50 μm and cladding diameter 125 μm, which are conventionally employed. Thus, 4 times the intensity can be realized.

Operation of Optical Tweezer Device

Next, operation of the optical tweezer device described above will be described. When image data is inputted at the unillustrated controller of this optical tweezer device, the controller generates control signals which control driving of the micromirrors of the DMD 110 on the basis of the image data that has been inputted, and angles of the reflections surfaces of the micromirrors of the DMD 110 are controlled on the basis of the generated control signals.

Illumination light, which is illuminated from the fiber array light source 112 through the lens system 114 to the DMD 110, is reflected in predetermined directions in accordance with the angles of the reflection surfaces of the micromirrors, and is thus modulated. The modulated light is magnified by the magnifying lens systems 126 and 128, and the light that has been magnified by the magnifying lens systems 126 and 128 is made incident on the respective microlenses provided at the microlens array 130.

The light that has been focused by the microlens array 130 enters the cores 140 which are arranged to correspond to a matrix pattern at the array head 132, and is guided in the optical fibers 136. When the light that has been focused by the microlens array 130 is incident at the cores 140 corresponding to the microlenses, highly efficient entry is possible. Moreover, as described above, focused beams which are close to diffraction boundary beams can be obtained from the light beams that enter the array head 132. Consequently, a focusing depth can be made deeper, and efficiency of coupling into the array head is raised.

Hence, the laser light is emitted from the end portions 138 of the optical fibers 136. Because the plurality of optical fibers 136 are two-dimensionally arranged in correspondence with the pixel portions of the DMD 110, the laser light is emitted from the array head 132 in accordance with an ON-OFF pattern of the DMD 110. As a result, minute bodies that are present on the stage 134 are captured in accordance with this pattern.

As has been described above, in the optical tweezer device of the present embodiment, the microlenses of the microlens array are arranged to correspond with the pixel portions of the DMD, and the optical fibers of the array head are arranged to correspond with the microlenses arranged at the microlens array. Therefore, laser light is emitted from the array head in accordance with ON-OFF patterns of the DMD. In consequence, minute bodies that are present on the stage can be captured in accordance with these patterns.

Further, because the optical fiber cores of the array head are disposed at focusing positions of the microlenses, the light that has been modulated at the DMD and focused by the microlenses can be irradiated into the corresponding optical fiber cores with good efficiency.

In particular, in the present embodiment, because a high-power, high-luminance light source is used, a focusing depth of the light beam that is irradiated to the array head can be deepened and the coupling efficiency can be raised. Furthermore, because the high-power, high-luminance light source is used, output of the array head can be raised, and trapping forces on minute bodies can be improved.

### SECOND EMBODIMENT

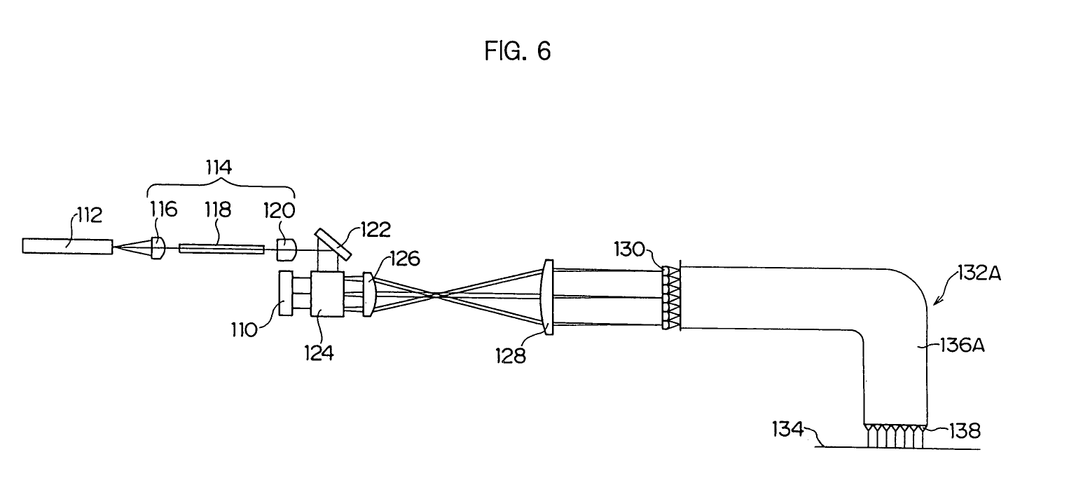

As is shown in FIG. 6, an optical tweezer device relating to a second embodiment has a structure the same as in the first embodiment, except that lengths of the optical fibers of the array head are longer. Accordingly, structural portions that are the same are assigned the same reference numerals, and explanations thereof are omitted.

Except that optical fibers 136A which are longer than the optical fibers 136 are used, an array head 132A is similar to the array head 132 shown in FIG. 2, having a structure which is provided with the cores 140, the claddings 142 and the spherical-faced emission side end portions 138. At incidence ends of the optical fibers 136A, the cores 140 are fixedly disposed at predetermined positions so as to be arranged in a matrix pattern in correspondence with the focusing positions of the microlens array 130. The end portions 138 at the emission ends of the optical fibers 136A are disposed close to the surface of the stage 134 so as to capture minute bodies that are present on the stage 134, and the end portions 138 are structured to be movable along the surface of the stage 134.

When image data is inputted at the unillustrated controller of this optical tweezer device, the angles of the reflection surfaces of the micromirrors of the DMD 110 are controlled in accordance with the image data. Illumination light, which is illuminated from the fiber array light source 112 through the lens system 114 to the DMD 110, is reflected in the predetermined directions, in accordance with the angles of the reflection surfaces of the micromirrors, and modulated. The modulated light is magnified by the magnifying lens systems 126 and 128, and is made incident on the respective microlenses provided at the microlens array 130.

The light that has been focused by the microlens array 130 enters the cores 140, which are arranged in correspondence with a matrix pattern at the array head 132A, and is guided in the optical fibers 136A. Hence, the laser light is emitted from the end portions 138 of the optical fibers 136A. Because this plurality of optical fibers 136A is two-dimensionally arrayed to correspond with the plurality of pixel portions of the DMD 110, laser light is emitted from the array head in accordance with the ON-OFF pattern of the DMD 110. As a result, minute bodies that are present on the stage 134 are captured in accordance with the pattern.

As has been described above, in the optical tweezer device of the present embodiment, the microlenses of the microlens array are arranged to correspond with the pixel portions of the DMD, and the optical fibers of the array head are arranged to correspond with the microlenses arrayed at the microlens array. Therefore, the laser light is emitted from the array head in accordance with ON-OFF patterns of the DMD. Consequently, minute bodies that are present on the stage can be captured in accordance with these patterns.

Further, because the incidence ends of the array head are fixedly arranged at predetermined positions, the light that has been modulated by the DMD and focused by the microlenses can be irradiated into the corresponding optical fiber cores with good efficiency.

Further still, because a high-power, high-luminance light source is used, coupling efficiency can be raised, output of the array head can be raised, and trapping forces on minute bodies can be improved.

Further yet, because the array head which is equipped with the long optical fiber portions is used, an output end of the array head can be a free end, and it is possible to employ a mechanism which is moved along the surface of the stage with ease. Accordingly, captured minute bodies can be moved to arbitrary positions.

### THIRD EMBODIMENT

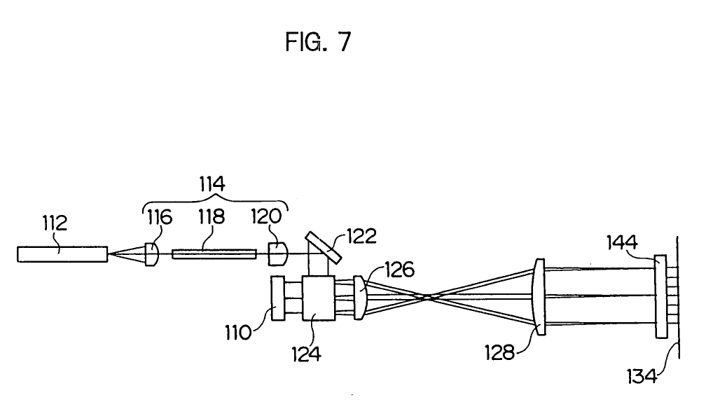

As shown in FIG. 7, an optical tweezer device relating to a third embodiment has a structure the same as in the first embodiment, except that a near-field array head, in which a light-blocking layer and tiny apertures are provided at the microlens array, is used. Accordingly, structural portions that are the same are assigned the same reference numerals, and explanations thereof are omitted.

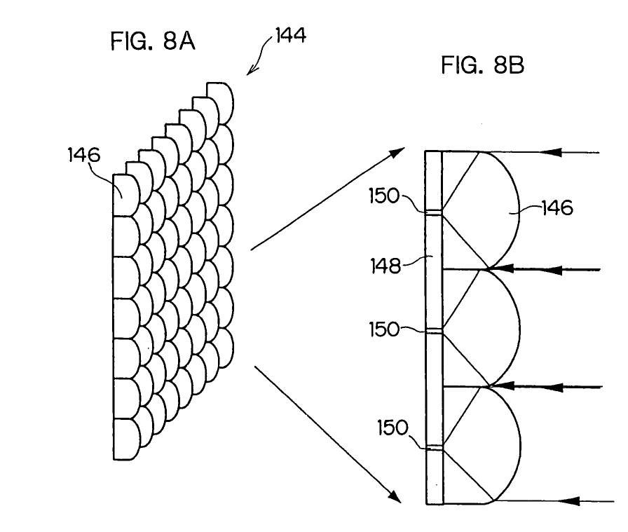

A near-field array head 144 is disposed at a position at which the DMD image is focused by the magnifying lens systems 126 and 128, and is disposed close to the surface of the stage 134. As shown in FIGS. 8A and 8B, the near-field array head 144 is equipped with a microlens array 146, at which the microlenses are provided in correspondence with the pixel portions of the DMD. At a light emission side face of the microlens array 146, a light-blocking layer 148 is provided. Tiny apertures 150 are formed in the light-blocking layer 148 at focusing positions of the microlenses. Diameters of the tiny apertures 150 are substantially 100 nm or thereabouts. When laser light is irradiated to the microlens array 146, near-field light (evanescent light) is effuses through these minute apertures.

This near-field array head 144 can be simply fabricated by vapor-depositing a metallic thin film of aluminium or the like at the light emission face of the microlens array 146 to form the light-blocking layer 148, and irradiating high-power laser light at the microlenses to form the tiny apertures 150 at focusing positions thereof.

When image data is inputted at the unillustrated controller of this optical tweezer device, the angles of the reflection surfaces of the micromirrors of the DMD 110 are controlled in accordance with the image data. Illumination light, which is illuminated from the fiber array light source 112 through the lens system 114 to the DMD 110, is reflected in the predetermined directions, in accordance with the angles of the reflection surfaces of the micromirrors, and modulated. The modulated light is magnified by the magnifying lens systems 126 and 128, and is made incident on the respective microlenses provided at the microlens array 146 of the near-field array head 144. The light that has entered the microlens array 146 is focused at vicinities of the tiny apertures 150 formed in the light-blocking layer 148.

Evanescent light exudes out through the tiny apertures 150. Because the tiny apertures 150 are two-dimensionally arranged to correspond with the plurality of pixel portions of the DMD 110, the evanescent light is emitted from the near-field array head 144 in accordance with the ON-OFF pattern of the DMD 110. As a result, minute bodies that are present on the stage 134 are captured in accordance with the pattern.

As has been described above, in the optical tweezer device of the present embodiment, the microlenses of the microlens array are arrayed to correspond with the pixel portions of the DMD, and the microlens array is used as a portion of the near-field array head. Consequently, laser light is emitted from the near-field array head in accordance with ON-OFF patterns of the DMD. Accordingly, minute bodies that are present on the stage can be captured in accordance with these patterns.

In particular, because near-field light is utilized in the present embodiment, high-intensity light energy with a diameter of less than the wavelength of the light, and which is localized, can be formed. Thus, it is possible to capture minute bodies smaller than the wavelength of the light (for example, 100 nm or less).

Further, because a high-power, high-luminance light source is used, coupling efficiency can be raised, output of the array head can be raised, and trapping forces on minute bodies can be improved.

Further yet, the near-field array head of the present embodiment has a simple structure, and thus fabrication is simple. Moreover, because the near-field array head is integrated with the microlens array, numbers of components can be reduced.

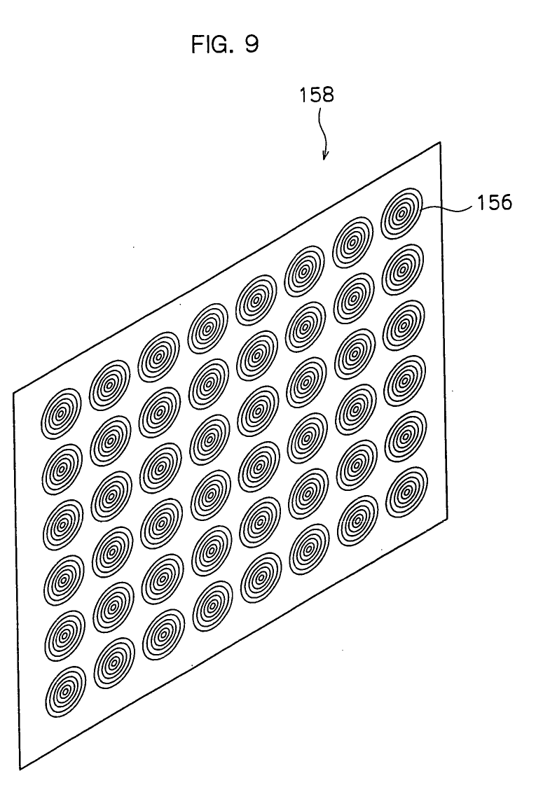

Note that it is also possible to use a usual microlens array, which does not include the light-blocking layer and tiny apertures, instead of the near-field array head described above. In such a case, minute bodies that are present on the stage are captured by light which is focused by the microlens array. For example, as shown in FIG. 9, a microlens array 158 at which fresnel lenses 156 are arranged in an array pattern can be used.

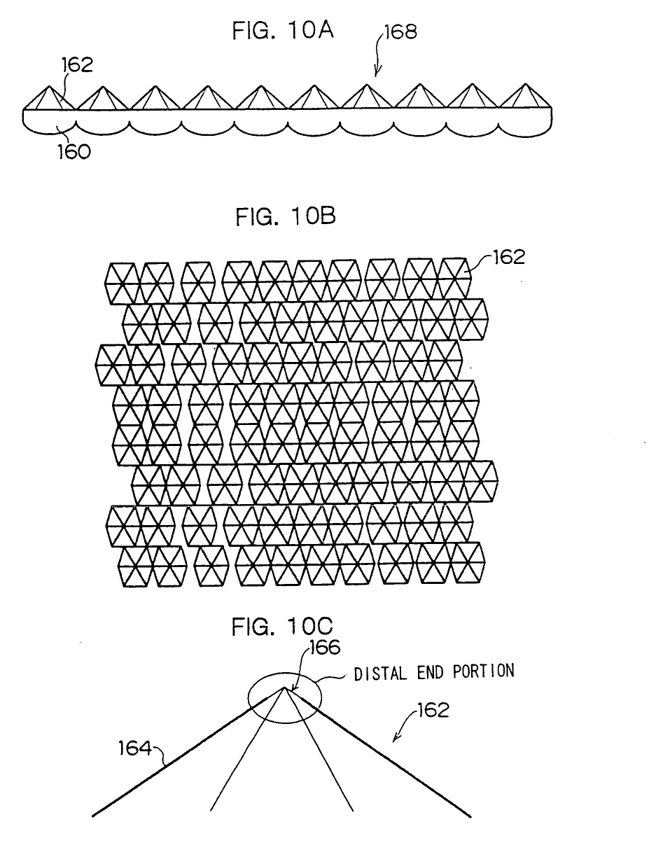

Further, instead of the near-field array head described above, it is possible to use a near-field array head 168 in which, as shown in FIGS. 10A and 10B, hexagonal cone-form protrusions 162 are formed in an array pattern by crystal growth of gallium nitride (GaN), silicon carbide (SiC) or the like at the light emission side face of a microlens array 160. As shown in FIG. 10C, the hexagonal cone-form protrusions 162 are covered by a light-blocking layer 164, which is formed by a metallic thin film of silver or the like. The light-blocking layer 164 is removed from distal end portions of the hexagonal cone-form protrusions 162, and thus tiny apertures 166 are formed. A diameter of the tiny apertures 166 is from 10 to 200 nm. At this near-field array head 168, when laser light is made incident on the microlens array 160, evanescent light is effused through the tiny apertures 166. Note that ultimate distal ends of the hexagonal cone-form protrusions 162 are flat if regarded microscopically.

GaN or SiC is transparent with respect to light with a wavelength of 400 nm, and there is no light-absorption thereat. Furthermore, GaN or SiC has a high refractive index and can suppress leakage of the evanescent light. Thus, light usage efficiency is improved. Moreover, because light losses are small, the aperture diameters can be made small, and smaller spots can be formed.

A near-field array head with the structure described above, which is provided with the hexagonal-cone form protrusions, can be produced by, for example, the following method. First, silicon dioxide (SiO₂) is deposited at a sapphire support. Thereafter, a pattern of dots with diameters of 5 μm and a period of 10 μm is preparatorily formed on this surface. Next, a GaN buffer layer is grown at low temperature by using the MOCVD process, the HVPE process or the like. Thereafter, single crystals of GaN are grown in hexagonal cone forms on this Gan buffer layer at high temperature.

Here, the distal end portions of the hexagonal cones are formed to be flat to serve as probe surfaces. Because these probe surfaces are formed by crystal growth, the probe surfaces can be levelled with atomic order accuracy.

A pitch of formation of the GaN single crystals is, for example, 10 μm. In a case in which a GaN-based semiconductor laser whose excitation wavelength is in the vicinity of 400 nm is used as the light source, even if the pitch of formation of the GaN single crystals is 0.4 μm to 1 μm, adequate light collection is possible.

Faces of the hexagonal-cone form GaN single crystals are coated with a thin film of silver. A thin film of silver can generate surface plasmons with optimum efficiency, and thus is excellent as a light-blocking layer. Next, the distal end portions of the hexagonal cone-form GaN single crystals are removed by dry-etching, and the tiny apertures are formed with aperture diameters of around 100 nm.

Finally, the microlenses are formed at a rear face of the sapphire support, at the positions of the GaN single crystals. The microlenses may be formed by plasma dry-etching utilizing a grayscale mask.

According to the optical tweezer device of the present invention, excellent effects are provided in that an increase in a number of channels when a pattern of light which is spatially modulated in accordance with control signals is to be irradiated is possible, and it is possible to consistently capture pluralities of minute bodies in accordance with highly detailed patterns.

What is claimed is:

1. An optical tweezer device comprising: a light source for illumination including a first plurality of optical fibers, emission ends of which are bundled, and semiconductor lasers, laser lights of which are coupled at respective incidence ends of the plurality of optical fibers;
a spatial light modulation device including a plurality of pixel portions which are two-dimensionally arranged, light modulation states of the pixel portions changing in accordance with respective control signals, and light beams which are incident at the plurality of pixel portions from the light source being modulated at the respective pixel portions; and an optical fiber array including a second plurality of optical fibers, incidence ends of which are two-dimensionally arranged with a pitch corresponding to the light beams that have been modulated by the pixel portions, and emission ends of which include spherical surfaces,
wherein a light beam from each emission end of the second plurality of optical fibers can be irradiated at a minute body for capturing a minute body at each optical fiber.

2. The optical tweezer device of claim 1, wherein the light source comprises a multiplex laser light source which multiplexes a plurality of the laser lights emitted from each of the plurality of semiconductor lasers and emits a light beam for illumination.

3. The optical tweezer device of claim 1, wherein the light source comprises a fiber light source which includes an optical fiber and a semiconductor laser whose laser light is coupled at an incidence end of the optical fiber, a core diameter of the optical fiber being constant, an emission end cladding diameter of the optical fiber being smaller than an incidence end cladding diameter thereof, and the emission end of the optical fiber being plurally bundled.

4. The optical tweezer device of claim 1, wherein the laser lights comprise a wavelength in the vicinity of 400 nm.

5. An optical tweezer device comprising:
a light source for illumination including a first plurality of optical fibers, emission ends of which are bundled, and semiconductor lasers, laser lights of which are coupled at respective incidence ends of the plurality of optical fibers;
a spatial light modulation device including a plurality of pixel portions which are two-dimensionally arranged, light modulation states of the pixel portions changing in accordance with respective control signals, and light beams which are incident at the plurality of pixel portions from the light source being modulated at the respective pixel portions;
a microlens array including a plurality of microlenses which are two-dimensionally arranged with a pitch corresponding to the plurality of pixel portions, the microlens array focusing the light beams that have been modulated by the pixel portions at the respective microlenses; and
an optical fiber array including a second plurality of optical fibers, incidence ends of which are two-dimensionally arranged with a pitch corresponding to focusing positions of the plurality of microlenses, and emission ends of which include spherical surfaces, wherein a light beam from each emission end of the second plurality of optical fibers can be irradiated at a minute body for capturing a minute body at each optical fiber.

6. The optical tweezer device of claim 5, wherein the incidence ends of the second plurality of optical fibers are fixedly disposed and the emission ends of the second plurality of optical fibers are movable.

7. The optical tweezer device of claim 5, wherein the light source comprises a multiplex laser light source which multiplexes a plurality of the laser lights emitted from each of the plurality of semiconductor lasers and emits a light beam for illumination.

8. The optical tweezer device of claim 5, wherein the light source comprises a fiber light source which includes an optical fiber and a semiconductor laser whose laser light is coupled at an incidence end of the optical fiber, a core diameter of the optical fiber being constant, an emission end cladding diameter of the optical fiber being smaller than an incidence end cladding diameter thereof, and the emission end of the optical fiber being plurally bundled.

9. The optical tweezer device of claim 5, wherein the laser lights comprise a wavelength in the vicinity of 400 nm.

10. An optical tweezer device comprising:
a light source for illumination including a plurality of optical fibers, emission ends of which are bundled, and semiconductor lasers, laser lights of which are coupled at respective incidence ends of the plurality of optical fibers;
a spatial light modulation device including a plurality of pixel portions which are two-dimensionally arranged, light modulation states of the pixel portions changing in accordance with respective control signals, and light beams which are incident at the plurality of pixel portions from the light source being modulated at the respective pixel portions; and
a microlens array including a plurality of microlenses which are two-dimensionally arranged with a pitch corresponding to the plurality of pixel portions, the microlens array focusing the light beams that have been modulated by the pixel portions at the respective microlenses,
wherein, at each microlens, the respective light beam that has been focused can be irradiated at a minute body for capturing a minute body at the each microlens.

11. The optical tweezer device of claim 10, wherein the microlenses comprise fresnel lenses.

12. The optical tweezer device of claim 10, wherein the light source comprises a multiplex laser light source which multiplexes a plurality of the laser lights emitted from each of the plurality of semiconductor lasers and emits a light beam for illumination.

13. The optical tweezer device of claim 10, wherein the light source comprises a fiber light source which includes an optical fiber and a semiconductor laser whose laser light is coupled at an incidence end of the optical fiber, a core diameter of the optical fiber being constant, an emission end cladding diameter of the optical fiber being smaller than an incidence end cladding diameter thereof, and the emission end of the optical fiber being plurally bundled.

14. The optical tweezer device of claim 10, wherein the laser lights comprise a wavelength in the vicinity of 400 nm.

15. An optical tweezer device comprising:
a light source for illumination including a plurality of optical fibers, emission ends of which are bundled, and semiconductor lasers, laser lights of which are coupled at respective incidence ends of the plurality of optical fibers;
a spatial light modulation device including a plurality of pixel portions which are two-dimensionally arranged, light modulation states of the pixel portions changing in accordance with respective control signals, and light beams which are incident at the plurality of pixel portions from the light source being modulated at the respective pixel portions;
a microlens array including a plurality of microlenses which are two-dimensionally arranged with a pitch corresponding to the plurality of pixel portions, the microlens array focusing the light beams that have been modulated by the pixel portions at the respective microlenses; and
a light-blocking layer provided at a light emission face of the microlens array and including a plurality of tiny apertures which are two-dimensionally arranged with a pitch corresponding to focusing positions of the plurality of microlenses,
wherein near-field light which effuses from each tiny aperture can be irradiated at a minute body for capturing a minute body at the each tiny aperture.

16. The optical tweezer device of claim 15, wherein the light source comprises a multiplex laser light source which multiplexes a plurality of the laser lights emitted from each of the plurality of semiconductor lasers and emits a light beam for illumination.

17. The optical tweezer device of claim 15, wherein the light source comprises a fiber light source which includes an optical fiber and a semiconductor laser whose laser light is coupled at an incidence end of the optical fiber, a core diameter of the optical fiber being constant, an emission end cladding diameter of the optical fiber being smaller than an incidence end cladding diameter thereof, and the emission end of the optical fiber being plurally bundled.

18. The optical tweezer device of claim 15, wherein the laser lights comprise a wavelength in the vicinity of 400 nm.
